(19) United States
(12) Patent Application Publication
(10) Pub. No.: US 2017/0339464 A1
(43) Pub. Date: Nov. 23, 2017

(54) MEDIA CONTENT RECEPTION AND SWITCHING MANAGEMENT

(71) Applicant: NAGRAVISION S.A., Cheseaux-sur-Lausanne (CH)

(72) Inventors: Saber HEDHLI, La Ciotat (FR); Marc BELLOCCHIO, Aubagne (FR)

(73) Assignee: NAGRAVISION S.A., Cheseaux-sur-Lausanne (CH)

(21) Appl. No.: 15/524,880

(22) PCT Filed: Nov. 6, 2015
(86) PCT No.: PCT/EP2015/075943

§ 371 Date: May 5, 2017

(30) Foreign Application Priority Data
Nov. 6, 2014 (EP) 14192135.3

(51) Int. Cl. H04N 21/472; H04N 21/462; H04N 21/41; H04N 21/438; H04N 21/6587; H04N 21/61

(52) U.S. Cl. CPC H04N 21/47202; H04N 21/6587; H04N 21/6125; H04N 21/4104; H04N 21/4383; H04N 21/4622

(57) ABSTRACT

A multimedia receiver and a method for managing switching reception of a first media content stream to a second media content stream. The multimedia receiver comprises a receiving device associated with a conditional access module and a media player configured to playback content from the first media content stream or the second media content stream. The receiving device is configured to receive a user command during playback of the first media content stream and to forward the user command to the conditional access module, the user command comprising at least one parameter defining reception of the second media content stream. The conditional access module is configured to up date, following reception of the user command, at least one descriptor in an information table associated with the first media content stream. The receiving device detects the information table update, generates an updated information table based on the at least one descriptor and forwards the updated information table to the conditional access module. The reception of the first media content stream is stopped and reception is switched to the second media content stream defined by the at least one parameter of the user command.

The present invention generally relates to the reception and playback of media content that is either broadcast or transmitted on demand from a head-end or a cloud. In particular, a multimedia receiver and a method for managing switching from reception of a first media content stream to reception of a second media content stream is disclosed.

### TECHNICAL BACKGROUND

Television sets, set-top boxes, personal computers, tablet computers, and the like are known devices on which media content can be received and, in some cases, played back or otherwise presented. In the domain of Over-The-Top (OTT) content delivery, audio, video, and other media content may be delivered to a media receiver over, e.g., the Internet.

The state of the art includes a system comprising a television set for receiving broadcast content, the television set having an OTT device connected thereto, the OTT device may be configured to receive video-on-demand (VOD) assets from, e.g., Internet cloud services, possibly using wireless means, and to inject a transport stream comprising the VOD asset into the television set for display. A viewer using the system to view a selected VOD asset from the cloud may decide to switch to another channel for receiving content broadcast according to DVB mode via a terrestrial transmitter or a satellite for example. Changing from one channel, or service, to another is a well-known operation, sometimes called zapping, which is usually done by the viewer with the aid of a remote control device. The remote control device sends a command to the television set but the OTT device may not know which command was sent to the television set. Accordingly, the OTT device cannot stop its injection of a transport stream of the VOD asset. Ideally, the OTT device should stop the injection of a currently playing asset whenever the viewer switches channel. In this way, the VOD asset could be resumed at the place where it left off in case the viewer may switch back to the channel on which the VOD asset was being played.

### SUMMARY

There is disclosed an OTT-compatible device which is configured to be connected to a media-playing/receiver device such as a television set and, for example, to inject transport stream packets (TS packets) on a TV channel identified by a triplet. A “triplet” is a term which is used in the broadcast industry to mean a set of three identifiers which uniquely identify a service (or channel) in the digital video broadcasting (DVB) suite of industry-accepted standards for digital television, a DVB triplet uniquely identifies a DVB-based service (or channel). A DVB triplet comprises an original network identifier (ONID), a transport stream identifier (TSID) and a service identifier (SID).

According to a first aspect, there is disclosed multimedia receiver comprising:
a receiving device for receiving one or more broadcast channels each comprising one or more broadcast contents and each being associated with a corresponding program map table, the receiving device comprising a service selection module configured to select a channel upon request; and
a peripheral device for receiving a VOD channel comprising a requested VOD content from a VOD server, the VOD channel being associated with at least one VOD program map table, the peripheral device being removably connectable to the receiving device via a bidirectional interface and configured to receive a multi-program transport stream;
   characterised in that:
the peripheral device is configured to further receive at least one of the broadcast contents and a corresponding program map table from the receiving device via the bidirectional interface, the peripheral device comprising an input selector to select either the broadcast content or the VOD content depending on at least one descriptor in the thus received program map table, the peripheral device further configured to process the thus selected content and to send the processed selected content to the receiving device via the bidirectional interface;
the peripheral device is still further configured to periodically send a program map table update command, via the bidirectional interface;
the receiving device is configured to send an updated program map table to the peripheral device whenever the program map table update command is received or whenever the channel change signal is received; and
the peripheral device is configured to send a stop signal to the VOD server to stop the reception of the VOD content when at least one descriptor in the updated program map table does not correspond to the VOD channel.

The multimedia receiver comprises a receiving device detachably connectable to a conditional access module, the receiving device having access to a media player configured to playback content provided within a first received media content stream or a second received media content stream. A conditional access module is a peripheral device in the sense that it is detachably connectable to the receiving device.

Examples of receiving devices according to embodiments of the present invention include but are not limited to: a set-top-box; a television set; or a personal computer. A system in which an embodiment of the present invention may be deployed includes a receiving device and a conditional access module—preferably removably connectable to the receiving device. Conditional access modules may be in the form of a PCMCIA (Personal Computer Memory Card International Association) module, connectable via a “common interface” or a dongle connectable to a universal serial bus interface. The receiving device is configured to receive broadcast content stream for example via satellite transmission, terrestrial broadcast transmission, cable transmission, or via a wired or wireless network performing streaming using for example IP (Internet Protocol) multicast or unicast techniques. This reception is usually a unidirectional reception. The conditional access module is also configured to receive media content stream, usually by wireless means and preferably in bi-directional fashion, thereby allowing for VOD content to be received. It can be said therefore that the receiving device is configured to receive a first content stream (preferably broadcast content stream) from a first input and that the conditional access module is configured to receive a second content stream (preferably VOD content stream) from a second input. The multimedia receiver, comprising the receiving device and the conditional access module is therefore configured to receive broadcast content stream or VOD content stream.

According to a second aspect, a receiving device is provided, the receiving device for receiving one or more broadcast channels each comprising one or more broadcast contents and each being associated with a corresponding program map table, the receiving device comprising a service selection module configured to select a channel upon request and further comprising a bidirectional interface; the receiving device being configured to update at least one of the program map tables whenever a channel change signal is received;

characterised in that:
the receiving device is further configured to update a further program map table corresponding to a further channel whenever a program map table update command is received via the bidirectional interface and to send an updated program map table via the bidirectional interface whenever a program map table is updated.

According to another aspect, there is provided, a peripheral device configured to receive at least one VOD service via a VOD input from a VOD server, the VOD service being associated with a corresponding program map table; characterised in that:
the peripheral device is further configured to:
   receive at least one broadcast content via a bidirectional interface;
   periodically send a program map table update command, via the bidirectional interface;
issue a stop signal to the VOD server to stop the reception of the VOD content when at least one descriptor in the updated program map table does not correspond to the VOD channel.

According to another aspect, provision is made for a method, using a multimedia receiver comprising a receiving device for receiving broadcast content and a peripheral module for receiving VOD content from a VOD server, the peripheral module being removably connected to the receiving device via a bidirectional interface, the broadcast content comprising a first plurality of services associated with a plurality of broadcast program map tables and the VOD content comprising at least one service being associated with a VOD program map table, the method for switching from a first service to a second service, comprising:
periodically sending, by the peripheral module, program map table update commands via the bidirectional interface;
generating, by the receiving device, an updated program map table including at least one descriptor corresponding to a broadcast content or a VOD content whenever a channel change request is received and whenever a program map table update command is received via the bidirectional interface;
sending the updated program map table to the peripheral device via the bidirectional interface;
sending, by the peripheral device, a stop command to the VOD server to stop receiving the VOD content when at least one descriptor in the updated program map table does not correspond to the VOD content.

As is known in the broadcast industry, a transport stream is a container format for transmission and storage of audio, video and program-specific information about a program (channel). The program-specific information, sometimes referred to as metadata, includes one or more program map tables (PMT). PMTs provide information on each program present in the transport stream (including the program number) and list the elementary streams that comprise the described program. According to embodiments of the present invention, the transport stream, comprising broadcast content, received via the first channel (input), includes one or more PMTs relative to the programs received via the first channel. Similarly, the transport stream received via the second channel (input) has at least one PMT relative to the VOD content (VOD asset). An appropriate remote server of a head-end, or more generally a cloud, may provide the VOD asset via a communication network such as the Internet. A cloud may be defined herein as a network of remote servers hosted on the Internet and used to store, manage, access to software and other resources, and process data in place of local servers or personal computers. The multimedia receiver, conditional access module, systems and methods according to this disclosure make use of such PMTs.

Following reception of a switching command by the receiving device, a service selection module included in the receiving device sends a channel change signal during playback of a current VOD asset, the conditional access module associated with the receiving device updates the PMT of the VOD asset, for example by changing identifier of a conditional access system managing user access to the VOD asset. This update is detected by a service selection module included in the receiving device thanks to an update signal transmitted by a media content stream input selector included in the conditional access module. The service selection module generates an updated PMT table and forwards it to the conditional access module via an interface thereof.

When the updated PMT table comprises a conditional access system identifier that is not part of the channel line up, reception of the PMT table featuring such information is detected by the conditional access module as an acceptation of the injection of the VOD asset.

The conditional access module may periodically generate a PMT table update command to force the receiving device to detect such update and generate the corresponding updated PMT table while the VOD asset is being injected by the conditional access module into the receiving device. The command may be sent via an interface between the conditional access module and the receiving device. Such interfaces are known and may be for example a Common Interface or a CableCARD interface, both of which are bidirectional interfaces.

When the receiving device receives a switching command to tune to an another channel, by a user using buttons of a remote control for example, the receiving device will send an updated PMT table based on the channel selected on the receiving device. The conditional access module will detect such change as the conditional access identifier in the PMT table is different from the conditional access identifier of the VOD asset. The conditional access module then stops the injection of the VOD asset and manages for example a broadcast DVB type media content stream selected on the receiving device and received from the receiving device.

According to a preferred embodiment, the media content stream input selector sends an end of session message to the server or cloud when it stops reception of a VOD asset.

### BRIEF DESCRIPTION OF THE DRAWINGS

The following detailed description refers to the attached drawings in which:

FIG. 1 shows a multimedia receiver comprising a receiving device associated with a conditional access module and a media player configured to play back media content provided by a broadcaster or by media servers according to a cloud-computing mode.

FIG. 2 shows a flowchart representing steps performed by the receiver device and the conditional access module when switching reception from a first media content stream to a second media content stream.

### DETAILED DESCRIPTION

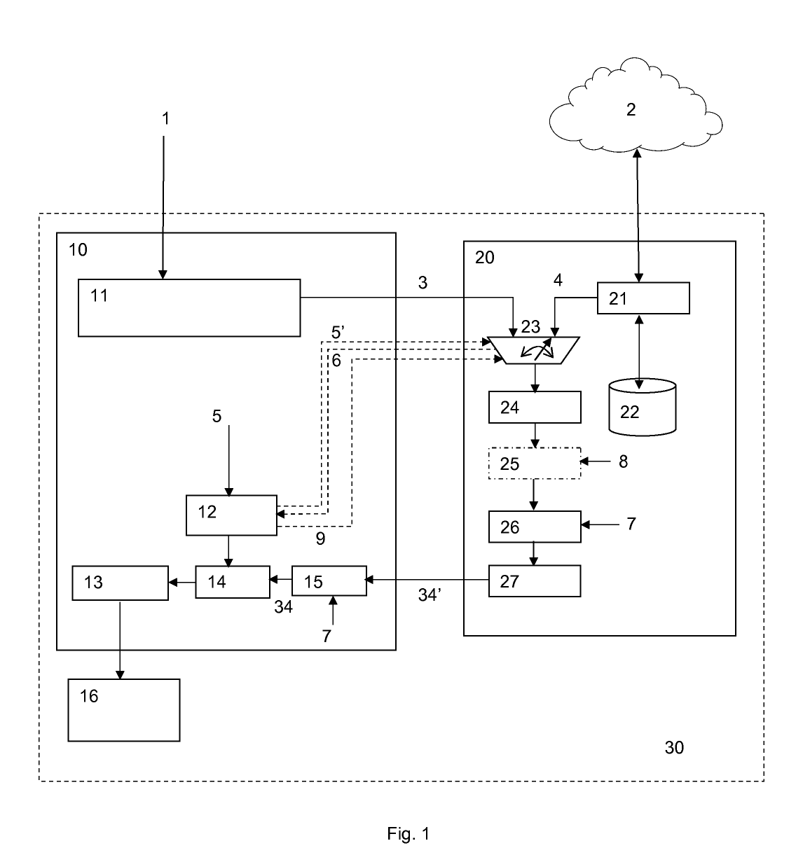

According to an embodiment of the multimedia receiver 30 shown by FIG. 1, a viewer may decide during the playback of a selected VOD asset, to switch to a broadcast channel providing DVB type media content in a unidirectional way via a broadcast channels input 1, e.g. the content is received in the form of data streams as provided for example by a satellite, a terrestrial broadcast emitter, cable, a wired or wireless network performing streaming by using for example IP (Internet Protocol) multicast or unicast.

The broadcast channels input 1 may be different from the VOD assets input 2 whereby VOD assets are received by the receiving device 10 via the conditional access module 20. Channel switching is commonly known as zapping. In a receiving device 10 according to embodiments of the present invention, the notion of zapping may include stopping the injection of a VOD asset and switching to a channel receiving another media content stream.

The receiving device 10 as illustrated by FIG. 1 comprises a tuner 11 for receiving media content stream from a broadcaster of barker channels for example. Barker channels are television channels dedicated to list or promote media content on other channels e.g., available VOD schedule and/or program descriptions and trailers.

The broadcast channels input 1 may be identified by a DVB triplet comprising a transport stream identifier, original network identifier, and a service identifier. The receiving device 10 is associated with a conditional access module 20 configured to receive content streams or VOD assets from a further source such as Internet or cloud and may comprise a storage device for storing received content.

According to a preferred embodiment, the conditional access module 20 is connected to the Internet. This connection may be a wired interface or may comprise a wireless link interface as for example a wireless local access network of type WiFi or a mobile phone network of type EDGE (Enhanced Data Rates for GSM Evolution), 3G, 4G, 5G etc., able to establish a wireless connection to Internet. The conditional access module 20 is preferably configured to connect to the receiving device 10 via an appropriate interface such as a common interface port of type CI, DVB-CI as defined in EN 50221 standards by CENELEC, the European Committee for Electrotechnical Standardization and DVB Ci+. According to an embodiment, the conditional access module 20 may be connected to the receiving device 10 via a high throughput Universal Serial Bus (USB) as for example USB 3.0, USB 3.1 or USB type-C.

The conditional access module 20, generally provided by a pay-TV operator, may be adapted to decrypt audio/video data received in the form of media data streams from a terrestrial transmitter, a satellite, an internet server, a cable network or a wireless network etc. Along with the media content, the pay-TV operator or provider also makes available the keys or control words necessary to decrypt the content using the conditional access module, the keys or control words being provided in encrypted format. A security module, reputed to be tamperproof and secure, may be provided to the user for storing security information such as keys and rights necessary for authentication and to allow the conditional access module to proceed with decryption. The security module may be in form of an electronic chip housed on a chip card which can be inserted into a card reader of the conditional access module.

The interface between the receiving device 10 and the conditional access module 20 (a common interface for example) is configured to send a multi-program transport stream 3 comprising content received by the tuner 11 of the receiving device 10 to the conditional access module 20 and to send a processed single program transport stream 34′ from the conditional access module 20 back to the receiving device 10. Generally the multi-program transport stream 3 comprises content encrypted with control words CW extractable from entitlement control messages ECM, as known in the domain of Pay-TV.

The conditional access module 20 may comprise decryption capabilities allowing for the decryption of the VOD single program transport stream 4 when it is encrypted.

The conditional access module 20, according to the embodiment of the present invention, further comprises an input selector 23 configured to choose whether it is to operate in the standard conditional access module mode as described above or to switch the input towards an output of a transport stream injector 21 for receiving a selected VOD asset.

In case of an encrypted VOD asset reception, the conditional access module 20 may decrypt the VOD asset with an appropriate key 8 using for example an AES decryptor 25.

According to a further embodiment, the conditional access module 20 may encrypt the VOD asset with a local key 7 before sending the corresponding transport stream 34′ to the receiving device 10 via an output interface module 27. The encryption with the local key 7 may use an AES (Advanced Encryption Standard) algorithm for example or any other suitable algorithm preferably using symmetric keys.

A decryptor 15 of the receiving device 10 decrypts with the local key 7 the transport stream 34′ received from the conditional access module 20 to obtain a decrypted compressed transport stream 34. This decrypted compressed transport stream 34 may then be forwarded, via an audio/video decoder 13 for decompressing, to a media player 16 associated with the receiving device 10.

The service selection module 12 associated with a demultiplexer 14 of the receiving device 10 allows selecting a channel to view either a content provided by the broadcast channels input 1 to which the tuner 11 is connected or a VOD content provided by the VOD assets input 2 of the conditional access module 20.

Since the conditional access module 20 cannot detect which button has been used for sending the channel switching command to the receiving device 10, the conditional access module 20 cannot stop the injection of the VOD asset.

A solution to this problem may be provided by detecting when a PMT table update is made following reception of the channel switching command and then to stop the VOD asset injection and inform the VOD server by an end of session message that the current VOD asset has been stopped. A VOD server could be in the conditional access module itself if it is reading VOD content from a local storage device or it could be one or a set of servers in the cloud configured to provide a selected VOD asset.

In the domain of Over-The-Top content delivery (OTT), audio, video, and other media content may be delivered over the Internet. An OTT-compatible device, as for example a conditional access module 20, is configured to be connected to a receiving device 10 or a set-top-box associated with a media player 16 such as a television set and to inject transport stream packets (TS packets) onto a selected television channel as identified by the DVB triplet.

The method of the present invention may preferably use DVB tables included in Program Specific Information (PSI), which are readily available for video-on-demand (VOD) assets or broadcast program content currently played back.

The Program Specific Information (PSI) is defined by the standard ISO/IEC 13818-1 MPEG-2 “Information technology—Generic coding of moving pictures and associated audio information: Systems”. The Program Specific Information data allows for a receiver to be configured in an automatic way for de-multiplexing and decoding different program streams. The Program Specific Information data is structured in tables comprising in particular:
a Program Association Table (PAT) indicating the localization for each service of a multiplex, namely the values of Packets Identifiers (PID) of packets of the transport stream (TS),
a Program Map table (PMT), identifying and indicating the localizations of the streams of each service,
a Conditional Access Table (CAT) providing information specific to the conditional access systems such as their identifier (CAS-ID) used in the multiplex comprising the localization of the Entitlement Management Messages (EMM) stream managing user access rights,

The PMT table may be combined with the Conditional Access Table (CAT). The resulting table (CA-PMT) forms a PMT table with Conditional Access (CA) identifiers used in the channel change managing method and the receiving device of the invention.

When the media player starts playback a content, it first stores one or more chunks of the content in a buffer of the media player and begins playback of the stored chunks while the next chunks are being downloaded from the network and processed by the conditional access module and the receiving device. A chunk is defined herein as a portion of a media content stream transmitted to the media player via a network. Each chunk contains the audio/video information packets and DVB tables necessary to render a selected duration, such as some seconds, of the content at a given resolution. CA-PMT tables may also be included in each chunk for defining conditional access system used in a selected VOD asset or DVB type broadcast content.

A viewer sends a channel change command 5 by pressing one or more buttons on a remote controller at an arbitrary time point during playback of a VOD asset by a receiving device 10 as shown by FIG. 1 to switch reception to another channel. The command 5 is received by the service selection module 12 of the receiving device 10 responsible for selecting various types of services from broadcast or VOD transport streams. The service selection module 12 then sends a corresponding channel change signal 5′ to the input selection module 23 of the conditional access module 20.

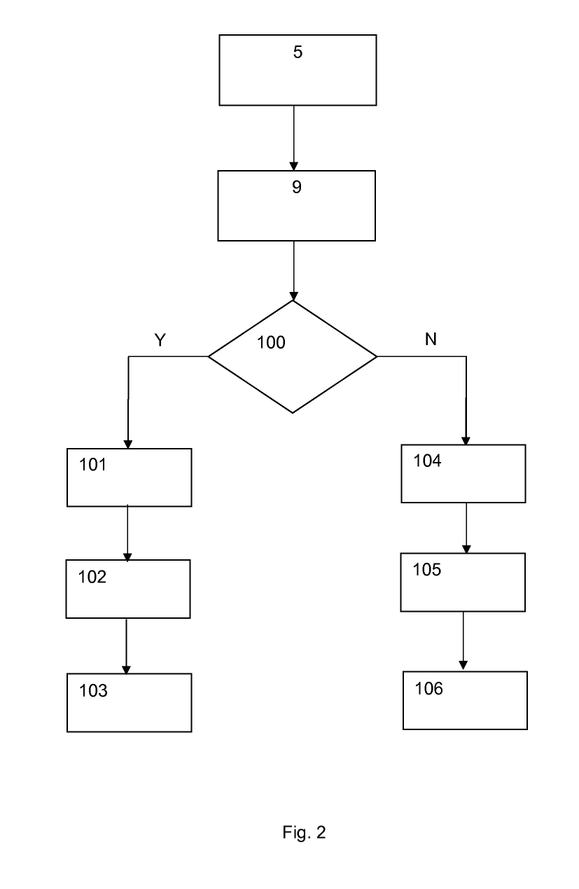

According to the flowchart of FIG. 2, the channel change signal 5′ enables switching reception of a first media content stream (VOD asset) provided by a current VOD channel CH1 to a viewer selected channel CH2 providing a second media content stream.

Following reception of the channel change command 5, the service selection module 12 of the receiving device 10 sends the channel change signal 5′ to the media content stream input selector 23 included in the conditional access module 20. Since a random access memory 22 associated with the transport stream injector 21 of the conditional access module 20 stores at least one chunk of the currently received VOD asset, the PMT table always remains available to the media content stream input selector 23. The media content stream input selector 23 then updates at least one descriptor in this PMT table and transmits a corresponding update alert signal 6 to the service selection module 12, the update alert signal 6 indicating that the PMT table has been modified.

The update may change at least one descriptor such as a version reference of the PMT table, an identifier of the conditional access system (CAS-ID) providing access controlled media content, the DVB triplet or any other descriptor associated with the media content stream provided by the selected channel CH2. The service selection module 12 generates, at detection of the update alert signal 6, an updated PMT 9 based on the at least one descriptor and the channel reference CH2 transmitted with the command 5.

The peripheral device receives the broadcast content from the receiving device (via the interface) as a plurality of programmes within a multi program transport stream (MPTS). By “injection” of the VOD it is meant including the VOD content as a new program in the MPTS thereby creating a new MPTS. The different services in an MPTS are identifiable via DVB descriptors such as DVB triplet. The VOD content can therefore be said to be injected into a particular TV channel identifiable by a DVB triplet. The peripheral device usually processes only a selected service from the MPTS and sends the processed service back to the receiving device (via the interface) as a single program transport stream (SPTS). For example, if the peripheral device is a CAM it will select the channel to be decrypted from within the MPTS according to the channel select command issued to the TV by a viewer and transferred to the CAM via the interface. The input selector then filters out the selected program to form an SPTS which is then processed and sent back to the receiving device.

The updated information table 9 is then forwarded to the media content stream input selector 23 of the conditional access module 20 for checking, step 100 in FIG. 2, for example, availability on the server or cloud of the updated conditional access system identifier related with the channel reference CH2.

If the conditional access system identifier CAS-ID is not available, e.g., the conditional access systems receives a N (no) response to the availability checking (step 100), the media content input selector 23 stops reception, of the current VOD asset (step 104) and switches reception input of the currently viewed VOD asset to the broadcast channels input 1 (step 105) defined by the channel reference CH2 providing the second media content stream. The receiving device 10 receives content stream from the broadcast channels input 1 (step 106).

If the conditional access system identifier CAS-ID is available, e.g., the conditional access system receives a Y (yes) response to the availability checking (step 100), the media content stream input selector 23 stays in its initial position without switching to the broadcast channels input 1. In this case, the media content stream input selector 23 injects another VOD asset (step 102) corresponding to the updated conditional access system identifier (CAS-ID) into the selected channel CH2. The receiving device 10 receives a VOD asset from the server or cloud via the VOD assets input 2, (step 103).

When the viewer sends a command 5 to switch reception from a current broadcast channel to a channel providing a VOD asset, the PMT table including a conditional access system identifier CAS-ID is updated directly by the service selection module 12 of the receiving device 10. The updated table is then forwarded to the media content stream input selector 23 of the conditional access module 20 for checking availability of the conditional access system identifier CAS-ID. The checking (step 100) is performed in a same way than in the case of switching from a channel providing a VOD asset to a channel providing broadcast content stream.

If the conditional access system identifier CAS-ID is available, e.g., the conditional access system receives a Y (yes) response to the availability checking (step 100), the media content stream input selector 23 switches reception to the VOD asset, the injection of the VOD asset into the selected channel may be restarted.

A VOD asset reception previously stopped by switching reception to a channel providing broadcast content may be resumed following a request, derived from the channel change command 5, sent by the receiving device 10 via the conditional access module 20 to a VOD asset server or cloud of the VOD provider. In response to the request, the conditional access module 20 receives via the transport stream injector 21 at least one chunk containing the PMT table corresponding to the PMT table of the at least one VOD asset chunk stored in the random access memory 22 before switching and the corresponding VOD asset.

If the conditional access system identifier CAS-ID is not available, e.g., the conditional access system receives a N (no) response to the availability checking (step 100), the media content stream input selector 23 stays in position of media content stream reception via the broadcast channels input 1, the VOD asset injection remaining stopped.

Although an overview of the inventive subject matter has been described with reference to specific example embodiments, various modifications and changes may be made to these embodiments without departing from the broader spirit and scope of embodiments of the present invention. For example, various embodiments or features thereof may be mixed and matched or made optional by a person of ordinary skill in the art. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are believed to be described in sufficient detail to enable those skilled in the art to practice the teachings disclosed. Other embodiments may be used and derived there from, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

1. A multimedia receiver comprising:
a receiving device for receiving one or more channels of a first type each comprising one or more contents of a first type and each being associated with a corresponding program map table, the receiving device comprising a service selection module configured to select a channel upon request; and
a peripheral device for receiving a Video-on-Demand (VOD) channel comprising a requested VOD content from a VOD server, the VOD channel being associated with at least one VOD program map table, the peripheral device being removably connectable to the receiving device via a bidirectional interface and configured to receive a multi-program transport stream;
wherein the peripheral device is further configured to:
receive at least one of the contents of the first type and a corresponding program map table from the receiving device via the bidirectional interface, the peripheral device comprising an input selector to select either the contents of the first type or the requested VOD content depending on at least one descriptor in the thus received program map table, the peripheral device further configured to process the selected content and to send the processed selected content to the receiving device via the bidirectional interface;
the peripheral device being further configured to periodically send a program map table update command, via the bidirectional interface;
wherein the receiving device is configured to send an updated program map table to the peripheral device whenever the program map table update command is received or whenever the channel change signal is received; and
wherein the peripheral device is configured to send a stop signal to the VOD server to stop the reception of the VOD content when at least one descriptor in the updated program map table does not correspond to the VOD channel.

2. The multimedia receiver according to claim 1, wherein the VOD server is comprised within the peripheral device.

3. The multimedia receiver according to claim 1, wherein the VOD server is external to the multimedia receiver.

4. The multimedia receiver according claim 1, wherein the peripheral device is a conditional access module, said processing of the selected content rendering the content accessible to the receiving device.

5. The multimedia receiver according to claim 1, wherein the at least one descriptor is one of a program map table version number, a conditional access system identifier, an original network identifier, a transport stream identifier or a service identifier.

6. A receiving device for receiving one or more channels of a first type each comprising one or more contents of a first type and each being associated with a corresponding program map table, the receiving device comprising a service selection module configured to select a channel upon request and further comprising a bidirectional interface;
the receiving device being configured to update at least one of the program map tables whenever a channel change signal is received;
the receiving device being further configured to update a further program map table corresponding to a further channel whenever a program map table update command is received via the bidirectional interface and to send an updated program map table via the bidirectional interface whenever a program map table is updated.

7. A peripheral device comprising:
at least one Video-on-Demand (VOD) service via a VOD input from a VOD server, the VOD service being associated with a corresponding program map table; and a VOD for receiving a bidirectional interface.
the peripheral device being configured to:
receive at least one content via the bidirectional interface;
periodically send a program map table update command, via the bidirectional interface; and
issue a stop signal to the VOD server to stop the reception of the VOD content when at least one descriptor in the updated program map table does not correspond to the VOD channel.

8. The peripheral device according to claim 7, wherein the peripheral device is a conditional access module.

9. The peripheral device according to either of claim 7, wherein the VOD input is a wireless input.

10. In a multimedia receiver comprising a receiving device for receiving content of a first type and a peripheral module for receiving Video-on-Demand (VOD) content from a VOD server, the peripheral module being removably connected to the receiving device via a bidirectional interface, the content of the first type comprising a plurality of services associated with a plurality of program map tables and the VOD content comprising at least one service being associated with a VOD program map table, a method for switching from a first service to a second service, comprising:
periodically sending, by the peripheral module, program map table update commands via the bidirectional interface;
generating, by the receiving device, an updated program map table including at least one descriptor corresponding to a content of the first type or a VOD content whenever a channel change request is received and whenever a program map table update command is received via the bidirectional interface;
sending the updated program map table to the peripheral device via the bidirectional interface;
sending, by the peripheral device, a stop command to the VOD server to stop receiving the VOD content when at least one descriptor in the updated program map table does not correspond to the VOD content.

11. The method according to claim 10, wherein the channel change request is received from a remote control device.
